(19) United States
(12) Patent Application Publication
(10) Pub. No.: US 2012/0041748 A1
(43) Pub. Date: Feb. 16, 2012

(54) Design support apparatus and method

(75) Inventor: Hiroyuki Orihara, Kawasaki (JP)

(73) Assignee: FUJITSU LIMITED, Kawasaki-shi (JP)

(21) Appl. No.: 13/137,407

(22) Filed: Aug. 11, 2011

(30) Foreign Application Priority Data
Aug. 13, 2010 (JP) 2010-181314

(51) Int. Cl. G06F 17/50

(52) U.S. Cl. 703/14

(57) ABSTRACT

A design support apparatus includes an extraction part, a creation part, and a correction part. The extraction part extracts from among a power supply layer and a ground layer a range related to a signal transmission of a pair of signal transmission circuit models disposed in a predetermined layer of a substrate model having a plurality of layers. The creation part processes, based on given constrained conditions, the power supply layer and ground layer in a range extracted by the extraction part and creates a layer model. The correction part corrects the substrate model based on the created layer model.

### CROSS-REFERENCE TO RELATED APPLICATION

This application is based upon and claims the benefit of priority of the prior Japanese Patent Application No. 2010-181314, filed on Aug. 13, 2010 the entire contents of which are incorporated herein by reference.

### FIELD

The embodiment discussed herein is related to a design support apparatus, method, and a computer-readable medium storing a design support program.

### BACKGROUND

When signals are transmitted in a semiconductor integrated circuit having a plurality of multilayer substrates, a current (hereinafter, referred to as a “return current”) is known to flow through a power supply layer or a ground (GND) layer in the direction opposite to that of a signal current.

In a portion in which a route of a return current is mismatched with that of a signal current by reason that a slit is formed in the power supply layer or the GND layer, an electromagnetic field becomes discontinuous, and at the same time, an electromagnetic field spreads out from the aforementioned portion. Accordingly, when a route of a return current deviates from that of a signal transmission, noise is known to be generated (see, for example, Japanese Laid-open Patent publications No. 2007-226566).

In recent years, as a result where the number of signals in a circuit increases due to the increase in functions of a semiconductor integrated circuit, a consumption current of the semiconductor integrated circuit increases. Further, a timing margin tends to be reduced due to the speeding up of a circuit operation.

In a circuit design, preferably, a circuit simulation in which a route of a return current is considered is performed and an effect on operations of a design target circuit due to noise generated by the mismatching between a return current and a signal current is previously verified.

When performing a circuit simulation in which a return current route is considered, a method for acquiring information on all current routes of the design target circuit and performing the aforementioned simulation is known.

However, all the route information units may be hard to be acquired at an initial stage of the design.

### SUMMARY

According to one aspect of the present invention, this design support apparatus includes: an extraction part to extract from among a power supply layer and a ground layer a range related to a signal transmission of a pair of signal transmission circuit models disposed in a predetermined layer of a substrate model having a plurality of layers; a creation part to process, based on given constrained conditions, the power supply layer and the ground layer in the range extracted by the extraction part and create a layer model; and a correction part to correct the substrate model based on the created layer model.

The object and advantages of the invention will be realized and attained by means of the devices and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an outline of a design support apparatus according to a first embodiment;

FIG. 2 illustrates one configuration example of hardware of the design support apparatus according to a second embodiment;

FIG. 3 is a block diagram illustrating a function of the design support apparatus according to the second embodiment;

FIG. 4 illustrates one example of a design target circuit;

FIG. 5 is a flowchart illustrating the entire processing of the design support apparatus;

FIG. 6 is a flowchart illustrating a printed-circuit board model correction processing;

FIGS. 7A and 7B illustrate an extraction of a reference cut-out range;

FIG. 8 illustrates one example of a reference model created in the cut-out range;

FIGS. 9A and 9B illustrate a creation example of a reference detour model;

FIGS. 10A and 10B illustrate a creation example of a reference transfer model; and

FIG. 11 illustrates one example of a correction processing of a semiconductor module.

### DESCRIPTION OF EMBODIMENTS

Preferred embodiments of the present invention will be described below with reference to the accompanying drawings.

First, a design support apparatus according to the embodiment will be described, and then the embodiments will be described more specifically.

### First Embodiment

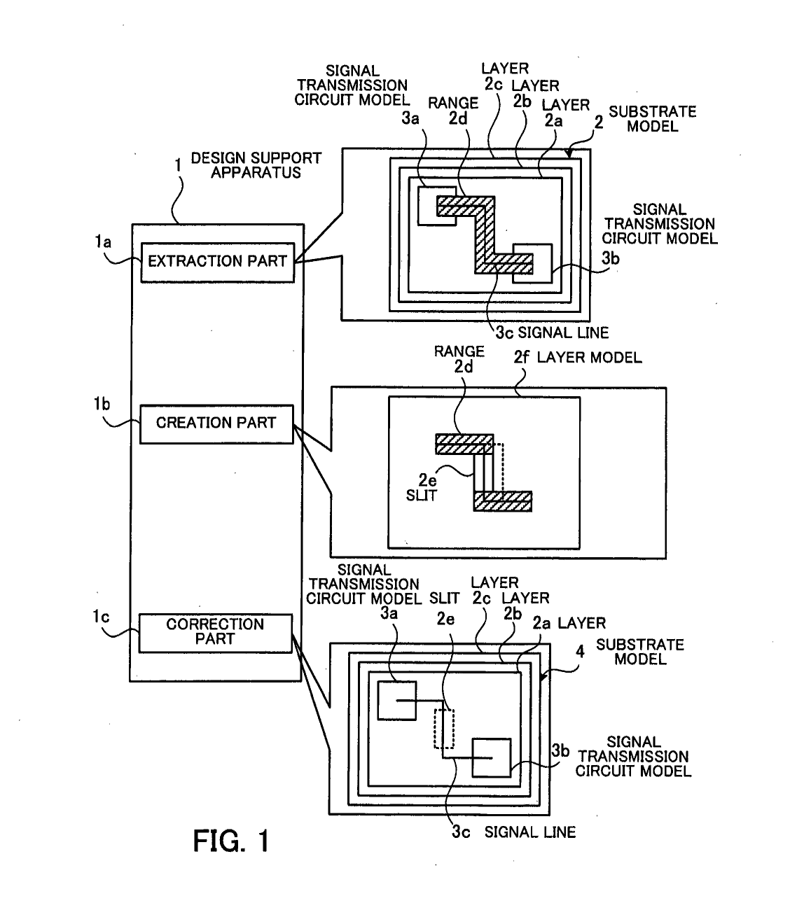

FIG. 1 illustrates an outline of the design support apparatus according to a first embodiment.

The design support apparatus (computer) 1 according to the present embodiment is an apparatus that creates a model for verifying an effect of noise exerted on a signal waveform transmitted between circuits by using a simulation.

The design support apparatus 1 has an extraction part 1a, a creation part 1b, and a correction part 1c.

The extraction part 1a extracts from among a power supply layer and a ground layer a range related to a signal transmission of a pair of signal transmission circuit models disposed on a predetermined layer of a substrate model having a plurality of layers.

Examples of the substrate model include a substrate model on which a driver I/O or receiver I/O is disposed, that of a driver package or receiver package, and that of a printed-circuit board (PCB).

FIG. 1 illustrates a substrate model 2. The substrate model 2 has layers 2a, 2b, and 2c from this side of a paper surface to a paper surface depth side. On the layer 2a, a pair of signal transmission circuit models 3a and 3b is disposed. The layer 2b is a layer adjacent to the layer 2a and is, for example, a GND layer. Further, the layer 2c is a layer adjacent to the layer 2b and is, for example, a GND layer. For the purpose of simplifying the explanation of FIG. 1, an illustration of the power supply layer is omitted.

The signal input and output terminals of the signal transmission circuit models 3a and 3b are connected to each other via the signal line 3c. Further, GND terminals of the signal transmission circuit models 3a and 3b are connected to the layer 2b by using via holes (not illustrated).

When transmitting a signal from the signal transmission circuit model 3a to the signal transmission circuit model 3b via the signal line 3c, a return current flows in the order corresponding to the signal transmission circuit model 3b, a GND line of the layer 2a, the via hole, the layer 2b, the via hole, the GND line of the layer 2a, and the signal transmission circuit model 3a.

The extraction part 1a can extract, for example, a predetermined range 2d of the layer 2b affected by an electromagnetic field generated due to signals transmitted through the signal line 3c.

Based on the given constrained conditions, the creation part 1b processes the layer 2b in the range 2d extracted by the extraction part 1a and creates a layer model. For example, when the above-described constrained conditions that a slit is formed in the layer 2b of the range 2d and a route for detouring the slit is formed within the layer 2b are given, the creation part 1b creates the layer model in which a return current detours the slit 2e within the layer 2b. In FIG. 1, a case where the slit 2e is formed so as to divide the range 2d into two is illustrated. In this case, the creation part 1b can create the layer model 2f of the layer 2b in which the slit 2e is cut out.

As another example, although the illustration is omitted, when constrained conditions that a slit is formed in the range 2d and a route for detouring the slit via another layer 2c is formed are given, the creation part 1b can create a layer model in which a return current detours the slit 2e via the another layer 2c.

The correction part 1c corrects the substrate model 2 based on the created layer model 2f.

In FIG. 1, as a result of correcting the substrate model 2, the substrate model 4 including the layer model of the layer 2b in which the slit 2e is cut out is illustrated.

When verifying generation of noise to this substrate model 4, the designer can acquire verification results in which a detour of a return current is considered. That is, even if failing to previously acquiring information on a return current route with respect to the substrate model 2, the designer can verify the generation of noise.

In addition, the extraction part 1a, the creation part 1b, and the correction part 1c can be realized by using a function of a central processing unit (CPU) of the design support apparatus 1. Further, one data temporarily created and another data acquired as a result of performing a processing at a process where the extraction part 1a, the creation part 1b, and the correction part 1c perform a processing can be stored in a data storage area of a random access memory (RAM) or hard disk drive (HDD) of the design support apparatus 1.

Hereinafter, the present embodiment will be described more specifically.

### Second Embodiment

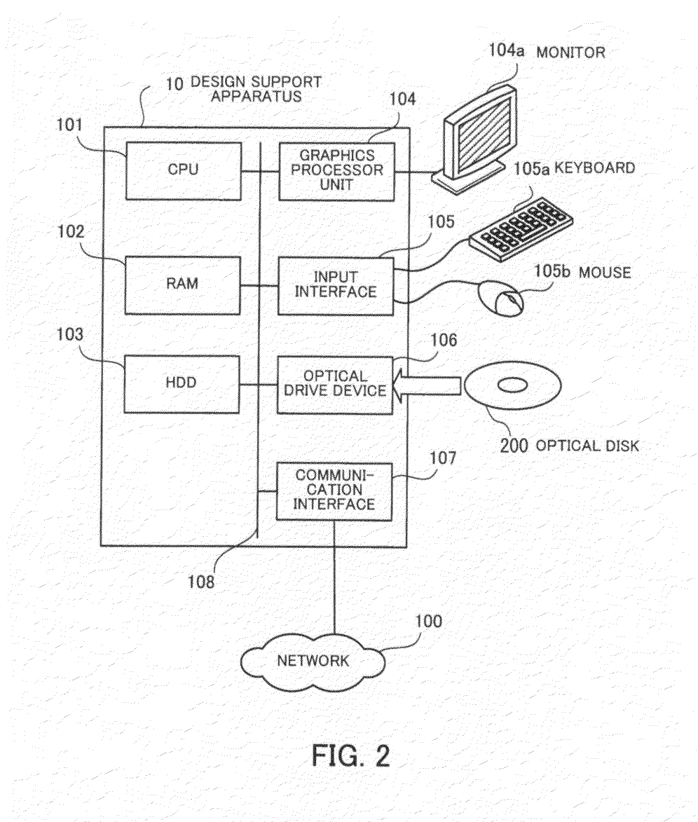

FIG. 2 illustrates one configuration example of hardware of a design support apparatus according to a second embodiment. The entire design support apparatus 10 is controlled by a CPU 101. To the CPU 101, a RAM 102 and a plurality of peripherals are connected via a bus 108.

The RAM 102 is used as a main storage for the design support apparatus 10. The RAM 102 temporarily stores at least part of an operating system (OS) program and application programs, which are run by the CPU 101. Further, the RAM 102 stores various data necessary for processing executed by the CPU 101.

As the peripherals connected to the bus 108, an HDD 103, a graphics processor unit 104, an input interface 105, an optical drive device 106, and a communication interface 107 are used.

The HDD 103 magnetically writes and reads the data to/from an internal disk. The HDD 103 is used as a secondary storage device for the design support apparatus 10. The HDD 103 stores the OS program, application programs, and various data. A semiconductor memory device, such as a flash memory, can also be used as the secondary storage device.

A monitor 104a is connected to the graphics processor unit 104. In accordance with an instruction from the CPU 101, the graphics processor unit 104 displays an image on the screen of the monitor 104a. A display device using a cathode ray tube (CRT) or a liquid crystal display can be used as the monitor 104a.

A keyboard 105a and a mouse 105b are connected to the input interface 105. The input interface 105 transmits signals, which are sent from the keyboard 105a and the mouse 105b, to the CPU 101. The mouse 105b is one example of pointing devices, and may be replaced with one of other pointing devices. The other pointing devices include, for example, a touch panel, a tablet, a touch pad, and a track ball.

An optical drive device 106 reads data recorded on an optical disk 200 by using laser light. The optical disk 200 is a portable recording medium on which data is recorded so as to be read by reflection of light. The optical disk 200 includes, for example, a digital versatile disk (DVD), a DVD-RAM, a compact disk read only memory (CD-ROM), and a CD-recordable/rewritable (CD-R/RW).

The communication interface 107 is connected to a network 100. The communication interface 107 transmits and receives data to and from other computers or communication devices via the network 100.

By the above-described hardware configuration, a processing function according to the present embodiment can be realized.

Within the design support apparatus 10 of the hardware configuration, the following functions are provided.

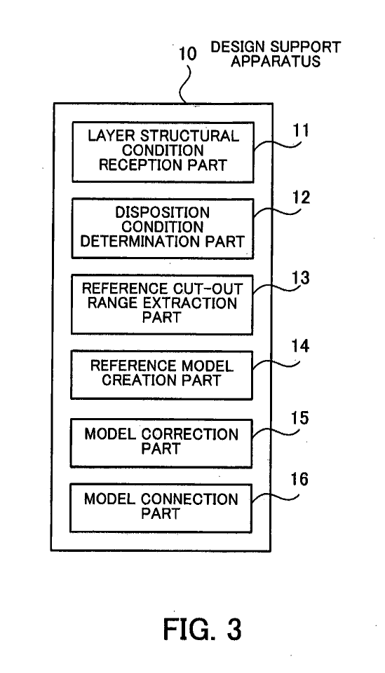

FIG. 3 is a block diagram illustrating a function of the design support apparatus according to the second embodiment.

The design support apparatus 10 includes a layer structural condition reception part 11, a disposition condition determination part 12, a reference cut-out range extraction part 13, a reference model creation part 14, a model correction part 15, and a model connection part 16.

The layer structural condition reception part 11 receives an input with regard to structural conditions of layers of a design target circuit using the keyboard 105a and mouse 105b of the designer. The design target circuit includes a printed-circuit board (PCB), a semiconductor package, a semiconductor module, and an arbitrary combination thereof.

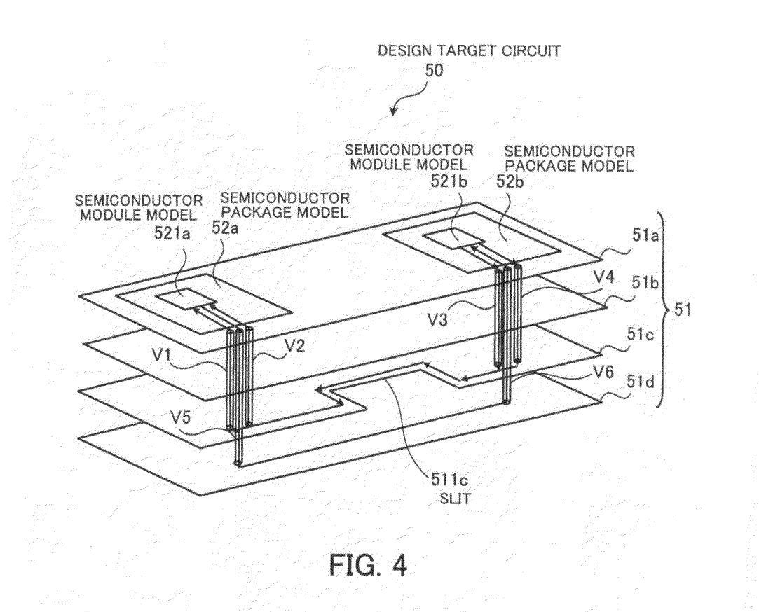

FIG. 4 illustrates one example of the design target circuit.

The design target circuit 50 illustrated in FIG. 4 is a circuit in which the printed circuit board and the semiconductor package are combined. Specifically, the design target circuit 50 has a printed-circuit board model configured by layers 51a, 51b, 51c, and 51d, and semiconductor package models 52a and 52b disposed on the layer 51a.

The layer 51a is a layer in which a signal wiring pattern and a GND pattern are mixedly present. The layer 51c configures a so-called solid GND layer. The layer 51d is a signal layer on which the signal wiring pattern is disposed.

The semiconductor package model 52a has a semiconductor module model 521a. The semiconductor package model 52b has a semiconductor module model 521b.

The semiconductor module model 521a supplies a signal to the semiconductor module model 521b via a signal line within the semiconductor package model 52a.

Further, FIG. 4 illustrates via holes V1 to V4 that electrically connect the layers 51a and 51c, and via holes V5 and V6 that electrically connect the layers 51a and 51d. The via hole V5 is disposed near and along the via holes V1 and V2. The via hole V6 is disposed near and along the via holes V3 and V4.

In the case of transmitting a signal from the semiconductor module model 521a to the semiconductor module model 521b, it is transmitted in the order corresponding to the semiconductor module model 521a, a signal line within the semiconductor package model 52a, a signal line formed in the layer 51a, the via hole V5, the layer 51d, the via hole V6, a signal line formed in the layer 51a, a signal line within the semiconductor package model 52b, and the semiconductor module model 521b.

When the GND layer is formed over or under the signal layer having disposed thereon the signal wiring pattern, a return current has a property that it flows through the GND layer over or under the signal line.

Accordingly, the return current flows in the order corresponding to the semiconductor module model 521b, the signal line in the semiconductor package model 52b, the signal line formed in the layer 51a, the via holes V3 and V4, the layer 51c, the via holes V1 and V2, the signal line formed in the layer 51a, the signal line within the semiconductor package model 52a, and the semiconductor module model 521a.

Here, in the layer 51c, a slit 511c is formed. Due to this slit 511c, the return current flows along it. Therefore, in the vicinity of the slit 511c, a transmission line of the return current is different from that of the signals, a loop area on which a current flows becomes large, and an electromagnetic wave radiated from the loop also becomes large. The design support apparatus 10 creates a power supply layer and ground layer model (hereinafter, referred to as a reference model) that can verify an effect of noise exerted on the design target circuit 50 due to electromagnetic waves radiated from the loop.

When creating a model of the design target circuit taken as an example of the design target circuit 50, the design support apparatus 10 performs an operation for creating the reference model with respect to each of the printed-circuit board, the semiconductor package, and the semiconductor module.

Hereinafter, a case where the reference model of a printed-circuit board is created will be described as an example.

Returning to FIG. 3 again, a description will be made.

The disposition condition determination part 12 determines whether disposition conditions of the printed-circuit board for the design target circuit received by the layer structural condition reception part 11 are present. The above-described determination can be performed, for example, based on whether a link section of the mounting design data related to the design target circuit is specified by the designer.

If the mounting design data is present, the disposition condition determination part 12 transmits it to the reference cut-out range extraction part 13. On the other hand, if the mounting design data is absent, the part 12 receives topology conditions on a topology disposed on the printed-circuit board, allocation of an element model that represents operations of an element, and operation frequencies of the topology by the designer. Then, the part 12 transmits the above-described received data to the reference cut-out range extraction part 13.

Here, the topology is referred to as a connection mode of elements such as transistors and resistors. Further, the topology conditions are those in which a wiring length is specified to the topology.

Further, operations of the element model may be described by using an I/O buffer information specification (IBIS).

The reference cut-out range extraction part 13 extracts a reference cut-out range for creating a reference model from a VDD layer and GND layer of the design target circuit received by the layer structural condition reception part 11. For the purpose of simplifying the explanation, a case where a reference cut-out range of the GND layer is extracted will be described below as an example.

When receiving mounting design data from the disposition condition determination part 12, the reference cut-out range extraction part 13 extracts a wiring route (Manhattan length) and the reference cut-out range from the disposition conditions included in the mounting design data.

On the other hand, when receiving the topology conditions from the disposition condition determination part 12, the reference cut-out range extraction part 13 finds out a GND current distribution due to a skin effect of a pattern section by using an electromagnetic solver based on a rise time or operation frequency conditions of a driver element. Further, the part 13 extracts a portion with a value more than or equal to a specified current threshold of the GND layer as the reference model cut-out range.

The reference model creation part 14 creates a reference model based on the extracted reference cut-out range. Then, the part 14 processes the created reference model according to condition specifications by the designer. Here, when extracting the reference cut-out range, the part 14 determines, based on the mounting design data, whether power supply division conditions are present in the mounting design data in the case where different power supply types are present in the same layer. On the condition that the power supply division conditions are absent, the part 14 processes the created reference model.

Specifically, the reference model creation part 14 receives a detour specification of a return current in the same layer and specification of a topology model of a detour portion by the designer (hereinafter, referred to as a “first specification”). At this time, the part 14 creates the reference model (hereinafter, referred to as a “reference detour model”) in which a slit is formed in a position corresponding to the specified topology model of the created reference model.

Further, when receiving the detour specification of a return current flowing over a plurality of layers and specification of the topology model by the designer (hereinafter, referred to as a “second specification”), the reference model creation part 14 designates the GND layer of the design target circuit nearest to the created reference model. Then, the part 14 creates the reference model in which a portion in the designated GND layer corresponding to the created reference model is cut out. Then, the part 14 disposes a via hole between the created reference models based on the specification of the topology model. Further, the part 14 forms a slit in a portion corresponding to the topology model of the created reference models, and connects the reference models by using the disposed via holes, thereby creating the reference models (hereinafter, referred to as a “reference transfer model”).

The model correction part 15 corrects the design target circuit based on the reference models created by the reference model creation part 14.

Specifically, the model correction part 15 connects the reference detour model or reference transfer model created by the reference model creation part 14 to a connection point of the topology model of the design target circuit to which an ideal ground is connected as the reference model.

Further, in the case where the power supply division conditions are present, the model correction part 15 connects the reference model on which the power supply division conditions are reflected to the connection point of the topology model of the design target circuit to which the ideal ground is connected as the reference model.

As described above, a case where the reference model of a printed-circuit board is created is described as an example; also with regard to the element model, the semiconductor package model, and the semiconductor module model, the reference model can be created in the same manner as in the case where the reference model of the printed-circuit board is created. In addition, with regard to the element model, the semiconductor package model, and the semiconductor module model, in the case where an existing topology is present, the designer can also create the reference model by using the existing topology in place of producing the topology conditions, allocation of the element model, and operating frequency of the topology of the design target circuit.

The model connection part 16 connects the element model, semiconductor package model, semiconductor module model, and printed-circuit board model equipped with the reference model corrected by the model correction part 15 to each other. In the design target circuit 50, for example, the above-described connection permits the part 16 to verify a current route and return current route of signals between the semiconductor module models 521a and 521b.

The design support apparatus 10 can store in the RAM 102 and the HDD 103 one data temporarily created and another data obtained by, performing a process in the process where the layer structural condition reception part 11, the disposition condition determination part 12, the reference cut-out range extraction part 13, the reference model creation part 14, the model correction part 15, and the model connection part 16 perform a process.

Next, the entire process of the design support apparatus 10 will be described.

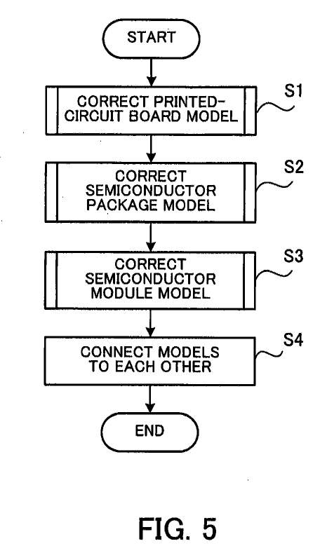

FIG. 5 is a flowchart illustrating the entire process of the design support apparatus.

(Step S1) The design support apparatus 10 performs a printed-circuit board model correction processing for correcting the printed-circuit board model. Then, the process proceeds to step S2. The printed-circuit board model correction processing will be described below.

(Step S2) The design support apparatus 10 performs a semiconductor package model correction processing for correcting the semiconductor package model. The printed-circuit board model correction processing will be described below.

(Step S3) The design support apparatus 10 performs a semiconductor module model correction processing for correcting the semiconductor module model. The printed-circuit board model correction processing will be described below.

(Step S4) The design support apparatus 10 connects the printed-circuit board model, semiconductor package model and semiconductor module model processed at steps S1 to S3 to each other. Further, the device 10 forms the current route and return current route of signals from the semiconductor module model on the signal output side up to the semiconductor module model on the signal input side. The apparatus 10 then ends the entire process.

This is the end of the description of the entire process.

Next, the printed-circuit board model correction processing at step S1 will be described.

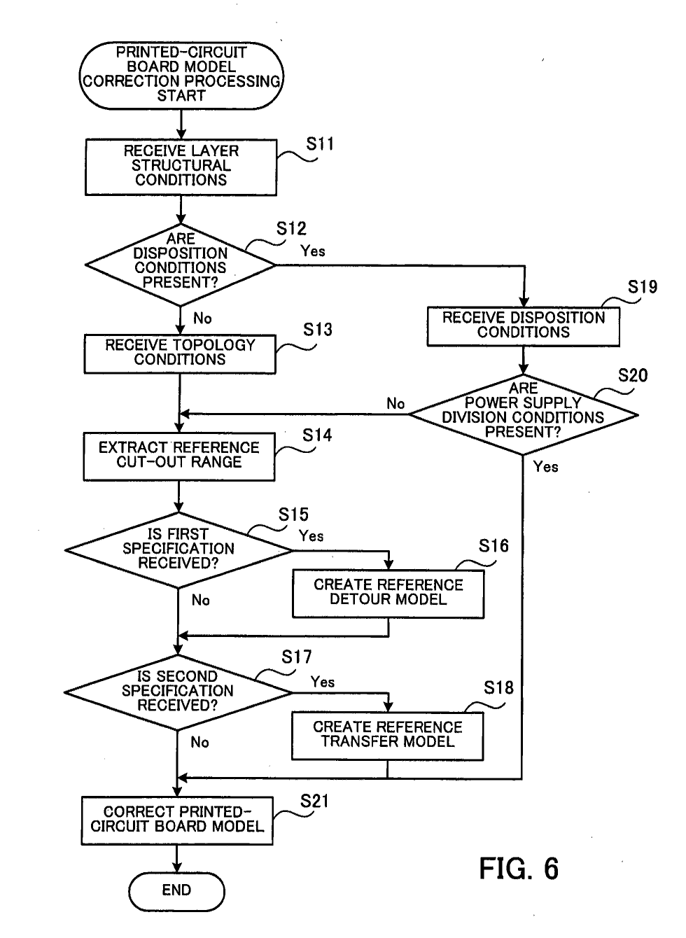

FIG. 6 is a flowchart illustrating the printed-circuit board model correction processing.

(Step S11) The layer structural condition reception part 11 receives a condition specification of a layer structure by the designer. The process then proceeds to step S12.

(Step S12) The disposition condition determination part 12 determines whether disposition conditions of the printed-circuit board are present. Based on the presence or absence of the mounting design data, for example, the part 12 can determine whether the disposition conditions are present. If Yes, the process advances to step S19. If No, the process proceeds to step S13.

(Step S13) The disposition condition determination part 12 receives the topology conditions. The process then proceeds to step S14.

(Step S14) The reference cut-out range extraction part 13 extracts a reference cut-out range of the VDD layer and GND layer located over or under the signal wiring based on analysis results of the above-described electromagnetic solver. The process then proceeds to step S15.

(Step S15) The reference model creation part 14 creates the reference model in the reference cut-out range. The part 14 determines whether to receive a detour specification of a return current and specification of the topology model of a detour portion by the designer (first specification) to the created reference model. If Yes, the process advances to step S16. If No, the process proceeds to step S17.

(Step S16) The reference model creation part 14 creates the reference detour model. The process then proceeds to step S17.

(Step S17) The reference model creation part 14 determines whether to receive a transfer specification of the layer and specification of the topology model by the designer (second specification) to the reference model created at step S15. If Yes, the process advances to step S18. If No, the process proceeds to step S21.

(Step S18) The reference model creation part 14 creates the reference transfer model. The process then proceeds to step S21.

(Step S19) The reference cut-out range extraction part 13 determines the disposition route (Manhattan length) and the reference cut-out range from the disposition conditions. The process then proceeds step S20.

(Step S20) The reference model creation part 14 determines whether division conditions of the reference cut-out range due to a difference of the power supply are present. If Yes, the process proceeds to step S21. If No, the process returns to step S14.

(Step S21) The model correction part 15 corrects the semiconductor package model and the semiconductor module model based on the reference detour model created at step S16, the reference transfer model created at step S18, or the division conditions. The process then ends the printed-circuit board model correction processing.

This is the end of the description of the printed-circuit board model correction processing.

The semiconductor package model correction processing at step S2 and semiconductor module model correction processing at step S3 of FIG. 5 can also be performed by using the same method as that of the printed-circuit board model correction processing.

Next, a specific example of an extraction of the reference cut-out range at step S14 will be described.

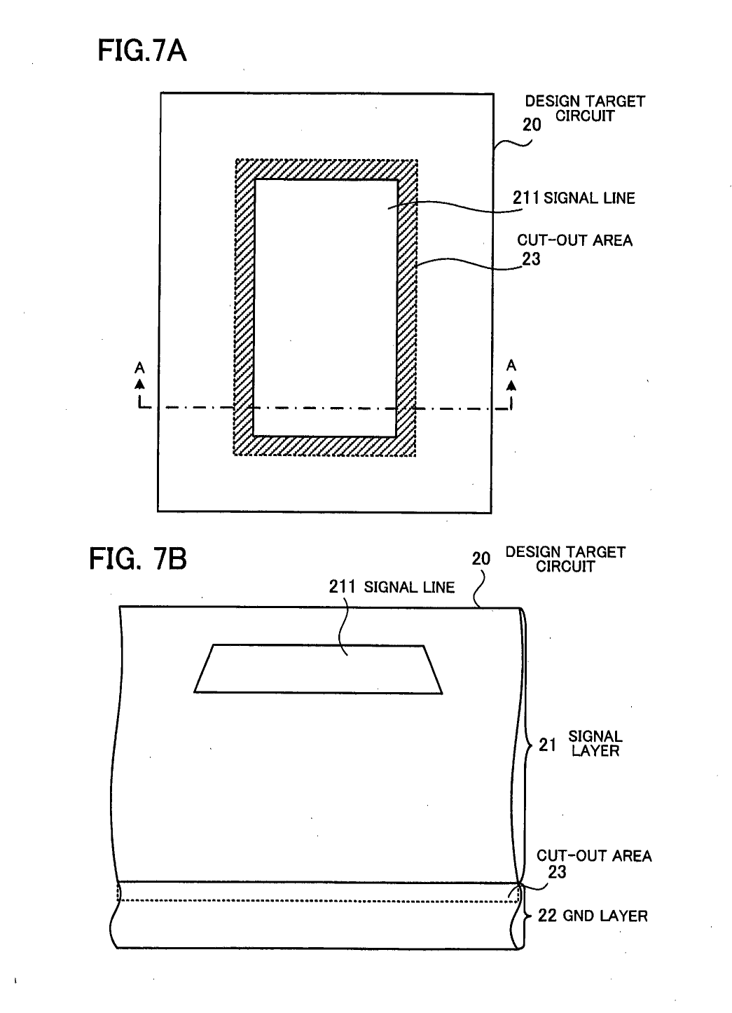

FIGS. 7A and 7B illustrate an extraction of the reference cut-out range.

The reference cut-out range extraction part 13 finds out a GND current distribution due to a skin effect of the pattern section by using an electromagnetic solver based on a rise time or operating frequency conditions of a driver element that transmits signals.

FIG. 7A illustrates a plan view of a part of the design target circuit 20, and FIG. 7B is a cross sectional view (partial omission) viewed from a dashed line A-A of the design target circuit illustrated in FIG. 7A.

In FIG. 7B, the cut-out area 23 in the GND layer 22 due to a skin effect of a signal line 211 disposed in the signal layer 21 is illustrated. The cut-out area 23 illustrates a range of a previously specified current threshold or more. The reference cut-out range extraction part 13 sets the cut-out area 23 to a reference cut-out range.

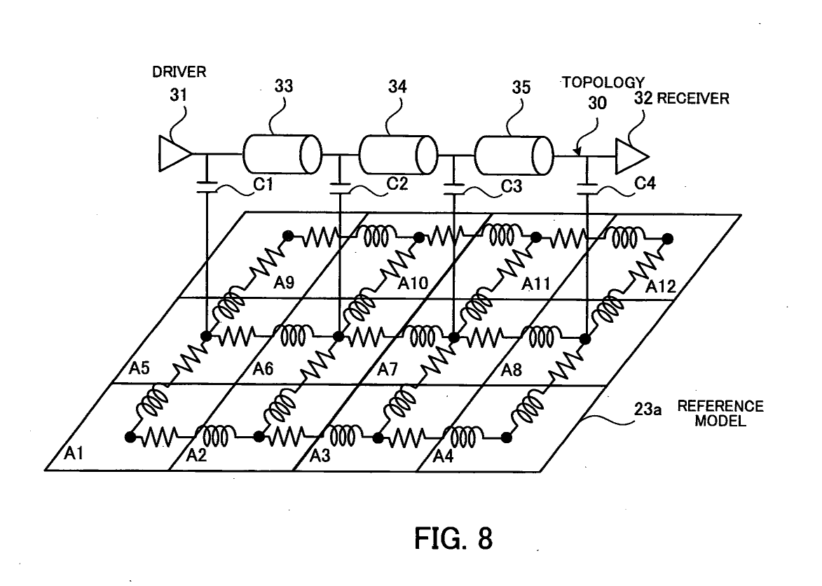

FIG. 8 illustrates one example of the reference model created in the reference cut-out range.

As illustrated in FIG. 8, the reference model 23a is connected to a topology 30 via capacitors C1 to C4. The reference model 23a is modeled with a plurality of resistance components being connected to a plurality of coil components. The topology 30 has a driver 31, a receiver 32, and a plurality of topology models 33 to 35 each having an impedance component and delay time of a signal line between the driver 31 and the receiver 32. The topology models 33 to 35 each have a resistance value corresponding to a distance of the signal line.

Hereinafter, as illustrated in FIG. 8, the reference model 23a is divided into twelve rectangular areas A1 to A12.

The capacitor C1 is connected to the area A5. The capacitor C2 is connected to the area A6. The capacitor C3 is connected to the area A7. The capacitor C4 is connected to the area A8. The topology model 33 is located over the areas A5 and A6 in a plan view. The topology model 34 is located over the areas A6 and A7 in a plan view. The topology model 35 is located over the areas A7 and A8 in a plan view.

Next, one example of the reference detour model will be described.

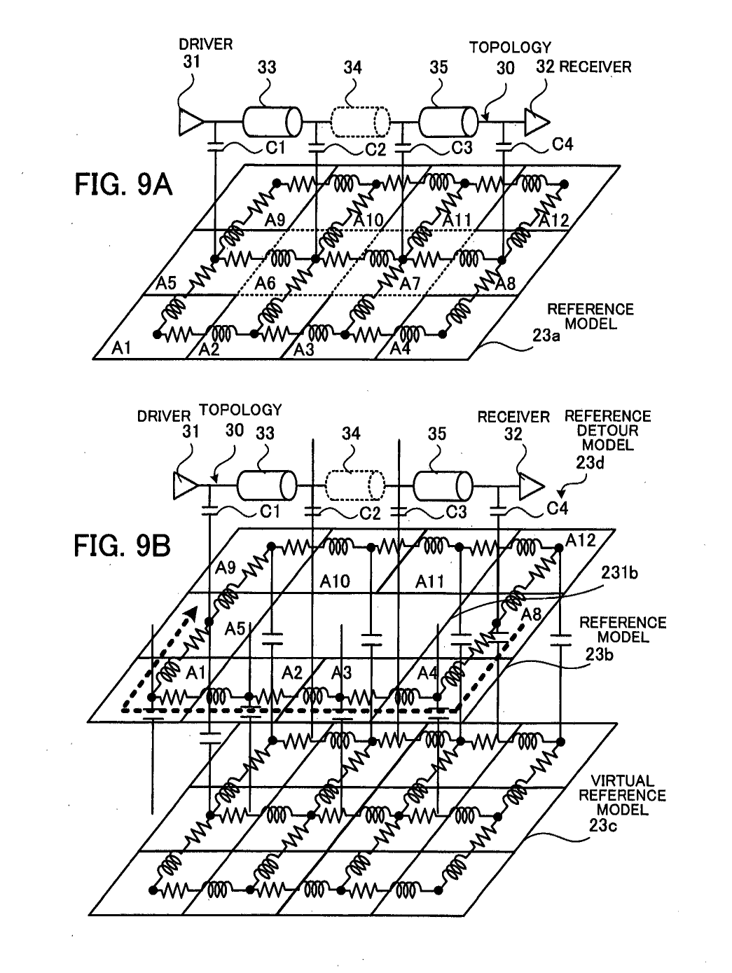

FIGS. 9A and 9B illustrate a creation example of the reference detour model.

When receiving the detour specification of a return current in the same layer and a specification of the topology model 34 of a detour portion by the designer, the reference model creation part 14 creates the reference detour model in which a slit is formed in the areas A6 and A7 corresponding to the topology model 34.

FIG. 9B illustrates the created reference detour model 23d.

The reference detour model 23d has a reference model 23b and a virtual reference model 23c.

In the reference model 23b, a slit 231b is formed in the areas A6 and A7. Further, the capacitors C2 and C3 connected to the areas A6 and A7 of the reference model 23a are connected to the infinite virtual reference model 23c. Suppose that the virtual reference model 23c has a uniform reference plane and is located in an infinite distance to the topology 30. Accordingly, the virtual reference model 23c scarcely has an influence on a return current route.

As a result in which the slit 231b is formed in the areas A6 and A7, a return current produced by the receiver 32 returns to the driver 31 via the capacitor C4, the areas A8, A4, A3, A2, A1, and A5, and the capacitor C1 as illustrated by a broken-line arrow in FIG. 9B. A route of the above-described return current is one example illustrating a shortest distance; further, the route also includes a route in which the return current returns to the driver 31 via the capacitor C4, the areas A8, A12, A11, A10, A9, and A5, and the capacitor C1.

Next, one example of the reference transfer model will be described.

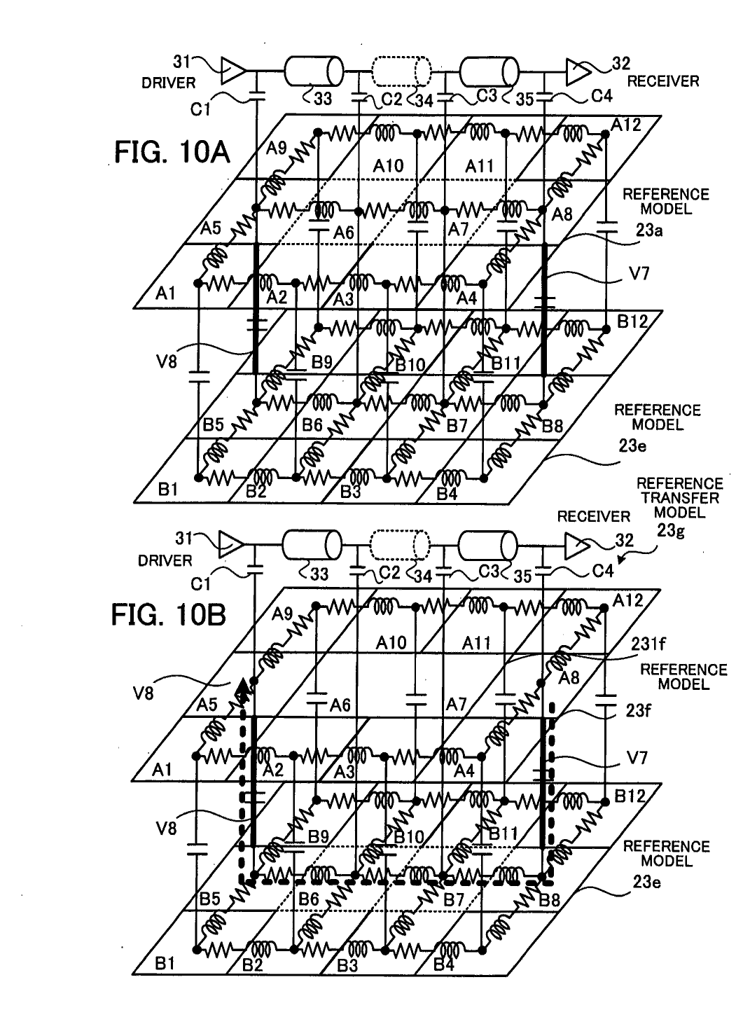

FIGS. 10A and 10B illustrate a creation example of the reference transfer model.

When receiving a detour specification of a return current flowing over a plurality of layers and specification of the topology model 34 by the designer, the reference model creation part 14 sets a reference model as a transfer destination. In FIG. 10A, the part 14 designates the GND layer of the design target circuit nearest to the reference model 23a. Then, the part 14 cuts out a portion of the designated GND layer corresponding to the reference model 23a, and creates the reference model 23e. Hereinafter, as illustrated in FIG. 10A, areas of the reference model 23e corresponding to the areas A1 to A12 are set to B1 to B12. Further, the part 14 disposes via holes between the reference models 23a and 23e based on the specification of the topology model 34. In FIG. 10A, as a result of specifying the topology model 34, the part 14 disposes a via hole V7 connecting the areas A8 and 88, and at the same time, disposes a via hole V8 connecting the areas A5 and B5 for detouring the areas A6 and A7 surrounded by a broken line of the reference model 23a.

FIG. 10B illustrates the created reference transfer model 23g.

The reference transfer model 23g has a reference model 23f and a reference model 23e.

In the reference model 23f, a slit 231f is formed in the areas A6 and A7. As a result in which the slit 231f is formed and the via holes V7 and V8 are disposed, a return current produced by the receiver 32 returns to the driver 31 via the capacitor C4, the area A8, the via hole V7, the areas B8, B7, B6, and B5, the via hole V8, the area A5, and the capacitor C1 as illustrated by a broken-line arrow in FIG. 10B.

Next, one example of the semiconductor module correction processing will be described.

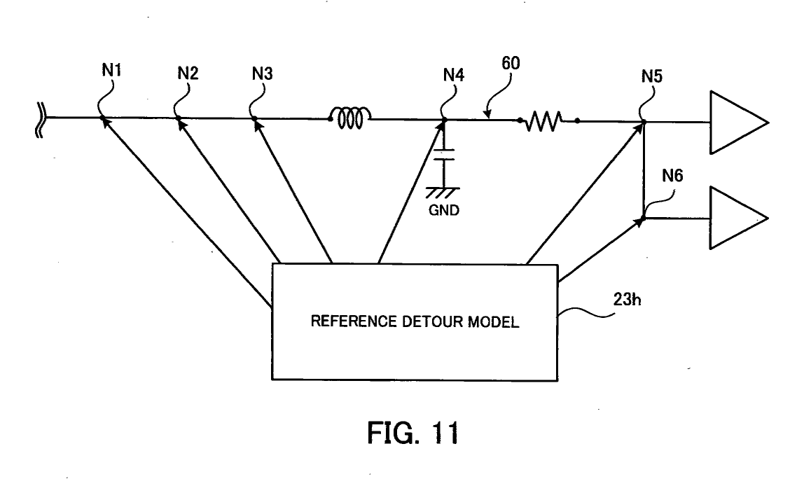

FIG. 11 illustrates one example of the semiconductor module correction processing.

FIG. 11 illustrates an example in which the model correction part 15 corrects the semiconductor module based on a topology 60 of the IBIS model including an electrical board description model (EBD) provided by a semiconductor module maker.

The topology 60 has nodes N1 to N6 for configuring connection points between an ideal GND and the reference detour model.

The model correction part 15 connects the nodes N1 to N6 and the reference detour model 23h created by using the above-described method.

As can be seen from the above sequence, when creating a reference model formed on a printed-circuit board even if mounting design data on the printed-circuit board is absent, the design support apparatus 10 can create a design target circuit in consideration of a return current route from the semiconductor module on the signal output side up to the semiconductor module on the signal input side.

In the topology study stage of an initial design, for example, this permits the design support apparatus 10 to verify design conditions (slit confinement) in consideration of a detour of a return current.

Examples of the aforementioned process using the design support apparatus 10 include a design verification of a multi-power supply printed-circuit board disposed over different power supplies, that of a printed-circuit board on which a GND is separated from each other by reason of a mixture of digital signals and analog signals, and that (e.g., a GND separation study of an oscillator) of parts in which mounting conditions are restricted.

In addition, a process performed by the design support apparatus 10 may be distributedly processed by a plurality of apparatuses. For example, one apparatus may perform a model correction processing, and create models having corrected therein the printed-circuit board, the semiconductor package, and the semiconductor module. Then, another apparatus may connect the above-described models to each other, and create the design target circuit.

The above-described processing functions can be realized with a computer. In that case, programs are provided which describe details of the processing functions to be executed by the design support apparatuses 1 and 10. By causing the computer to execute the programs, the above-described processing functions are realized on the computer. The programs describing the details of the processing functions can be recorded on a computer-readable recording medium. The computer-readable recording medium includes a magnetic recording device, an optical disk, a magneto-optical recording medium, and a semiconductor memory. The magnetic recording device includes a hard disk drive (HDD), a flexible disk (FD), and a magnetic tape. The optical disk includes a DVD, a DVD-RAM, a CD-ROM, and a CD-R/RW. The magneto-optical recording medium includes a magneto-optical disk (MO).

When the programs are circulated on markets, for example, a portable recording medium, such as a DVD or a CD-ROM, recording the programs is commercialized for sale. The programs can also be circulated by storing the programs in a memory of a server computer, and by transferring the stored programs from the server computer to other computers via a network.

The computer for executing the programs stores the programs recorded on the portable recording medium or the programs transferred from the server computer in its own memory, for example. The computer reads the programs from its own memory and executes processing in accordance with the programs. Alternatively, the computer can execute processing in accordance with the programs by directly reading the programs from the portable recording medium. The computer may also execute processing in such a way that, whenever part of the programs are transferred from the server computer connected via a network, the computer sequentially executes processing in accordance with the received program.

Also, at least part of the above-described processing functions may be realized with an electronic circuit, such as a digital signal processor (DSP), an application specific integrated circuit (ASIC), or a programmable logic device (PLD).

As can be seen from various embodiments discussed above, the proposed design support apparatus, method, and program permit a design target circuit to be verified by using a relatively small quantity of information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A design support apparatus comprising:
an extraction part to extract from among a power supply layer and a ground layer a range related to a signal transmission of a pair of signal transmission circuit models disposed in a predetermined layer of a substrate model having a plurality of layers;
a creation part to process, based on given constrained conditions, the power supply layer and ground layer in a range extracted by the extraction part and create a layer model; and
a correction part to correct the substrate model based on the created layer model.

2. The design support apparatus according to claim 1,
wherein the extraction part extracts a range affected by an electromagnetic field generated by a signal transmitted through a line between the signal transmission circuits.

3. The design support apparatus according to claim 2,
wherein the extraction part extracts a range of a predetermined value or more of a current distribution in consideration of a skin effect.

4. The design support apparatus according to claim 1,
wherein the extraction part extracts a VDD layer and GND layer nearest to a layer on which the signal transmission circuit model is disposed.

5. The design support apparatus according to claim 1,
wherein the creation part creates, according to conditions of information for specifying a slit, the layer model in which a return current detours the slit.

6. The design support apparatus according to claim 1,
the creation part creates, according to a specification of a layer for flowing through the other layers except the power supply layer and the ground layer, the layer model in which a return current flows over the plurality of layers.

7. A design support method comprising:
extracting from among a power supply layer and a ground layer a range related to a signal transmission of a pair of signal transmission circuit models disposed in a predetermined layer of a substrate model having a plurality of layers;
processing, based on given constrained conditions, the power supply layer and ground layer in the extracted range and creating a layer model; and
correcting the substrate model based on the created layer model.

8. A non-transitory computer-readable medium storing a design support program for causing a computer to execute:
an extraction procedure for extracting from among a power supply layer and a ground layer a range related to a signal transmission of a pair of signal transmission circuit models disposed in a predetermined layer of a substrate model having a plurality of layers;
a creation procedure for processing, based on given constrained conditions, the power supply layer and ground layer in a range extracted by the extraction procedure and creating a layer model; and
a correction procedure for correcting the substrate model based on the created layer model.
